(19) United States
(12) Patent Application Publication
(10) Pub. No.: US 2022/0072577 A1
(43) Pub. Date: Mar. 10, 2022

(54) FLUID GUARD NOZZLE

(71) Applicants: Ramgopal Vissa, Hyderbad (IN); Sriramu Sajji, Hyderbad (IN); Michael Connelly, Cincinnati, OH (US); Jainagesh Sekhar, Cincinnati, OH (US)

(72) Inventors: Ramgopal Vissa, Hyderbad (IN); Sriramu Sajji, Hyderbad (IN); Michael Connelly, Cincinnati, OH (US); Jainagesh Sekhar, Cincinnati, OH (US)

(73) Assignee: MHI Health Devices, LLC., Cincinnati, OH (US)

(21) Appl. No.: 17/462,052

(22) Filed: Aug. 31, 2021

Related U.S. Application Data
(60) Provisional application No. 63/076,519, filed on Sep. 10, 2020.

(51) Int. Cl. B05B 15/16

(52) U.S. Cl. CPC B05B 15/16

(57) ABSTRACT

Presented is a fixture to be attached to a device, and method of use thereof, designed to project a fluid upon a surface or object where the distance between the surface or object and the source of applied fluid is in need of precise control. Such need of distance control could be where the fluid, due to temperature or abrasiveness might damage the surface if applied to closely or where the distance may need to be precise where a fluid, such as paint, needs to be applied at a specific distance for optimal coverage.

### CROSS-REFERENCE TO RELATED APPLICATIONS

This application claims the benefit of U.S. provisional application 63/076,519 filed on Sep. 10, 2020 the disclosure of which is incorporated by reference herein in its entirety.

### BACKGROUND

Many commercial, industrial, and household uses exist for the application of fluids onto objects and surfaces. At times these fluids may be heated or cooled by an apparatus that may reach a temperature that could be damaging to an object or surface if the apparatus is brought to close to the object or surface. In other cases, if the apparatus, or its application nozzle is brought too close to a surface, an over-application of the fluid may occur causing flaws in the applied coating or wasting of the fluid.

What is needed is a device to prevent a fluid nozzle from being brought too near to a surface or to provide the optimum application distance from the surface. Such a device could be used to prevent overheating or burning of surfaces from heat guns or steaming devices. Damage caused by pressure washers could be minimized and over-application of paints, coatings and other surface treatments might be prevented as well.

### SUMMARY

This application discloses a fixture to be attached to a device that is designed to project a fluid upon a surface or object where the distance between the surface or object and the source of applied fluid is in need of control. Such need of distance control could in a case where the fluid, due to temperature or abrasiveness might damage the surface if applied to closely. Also, the distance may need to be precise where a fluid, such as paint, needs to be applied at a specific distance for optimal coverage.

The fluid nozzle guard describe is comprised of a means to attach the guard to exhaust or fluid port of a fluid projection device such as a paint sprayer, heat gun, grit blaster, pressure washer or steam applicator. The means to attach the guard is equipped with at least one spacing arm that extends from the fluid source to the surface to be treated and prevents the fluid port from coming too close to the surface. The spacing arms may be designed to provide the optimal distance for proper application of the fluid. Multiple spacing arms may be utilized. Protective tips may be attached to the ends of the spacing arms for direct contact with the surface which will give the user a positive point of reference of position for correct application of the fluid. The arms may be constructed of solid rigid material, but in a preferred embodiment may be comprised of coiled springs.

### DRAWING—FIGURES

FIG. 1 is an overall view of an embodiment of a fluid nozzle guard comprised of two spacing arms which are comprised of springs.

FIG. 2 is a front view of an embodiment of a fluid nozzle guard comprised of two spacing arms which are comprised of springs.

FIG. 3 is a rear view of an embodiment of a fluid nozzle guard comprised of two spacing arms which are comprised of springs.

FIG. 4 is an overall view of an embodiment of a fluid nozzle guard comprised of one spacing arm which is comprised of a spring.

FIG. 5 is an overall view of an embodiment of a fluid nozzle guard comprised of three spacing arms which are comprised of springs.

FIG. 6 is an overall view of a superheated steam generator having a fluid nozzle guard attached to its steam exhaust port allowing for spacing between the port and a working surface.

### DRAWING—REFERENCE NUMERALS

| | | | |
|---|---|---|---|
| 10 | fluid nozzle guard | 20 | spacing arm |
| 25 | cap | 30 | base |
| 35 | threads | 50 | superheated steam generator |

### DESCRIPTION

Presented is a simple apparatus, guard or bumper for the maintenance of an optimal distance between a fluid delivery or exhaust nozzle and a work surface. The apparatus is comprised of a spring that is mechanically attached to a fluid projection device near the nozzle or exhaust port of the device generally parallel or in line with the direction of the exhaust nozzle and the projected fluid flow. Contemplated projection devices may be included, but not limited to, the list of steam generators, heat guns, pressure washers, grit blasters and paint sprayers. The spring may be a coil spring configured to a specified length, depending on the application, which will allow the exhaust end of the projection device to get no closer than the length of the spring thereby protecting the working surface from the projected fluid. The length will be such that the fluid is applied in the “sweet spot” where the fluid is effectively applied without any damage to the surface or production of wasted fluid. The spring, while allowing an approach of a set distance from a surface, will allow some lateral movement parallel to the working surface as the spring flexes and bends, but not enough to reduce the distance between the nozzle and the surface resulting in surface damage. It is also contemplated that the spring of the guard is not to ne limited by the spring coefficient, pitch, stiffness or material comprising the spring.

The mechanical attachment of the guard to, or near, the exhaust nozzle may be permanent or temporary. Temporary attachments may be adjustable. The guard my be welded or affixed with screws, rivets or other fasteners to the nozzle. The base of the nozzle may be threaded allowing for a guard provided with a like threaded ring affixed to the spring to be screwed onto the nozzle. Clamping and friction fitting of the guard equipped with a non-threaded ring are also contemplated.

The length of the spring will depend on the fluid that that is projected and the velocity and strength of the projection. The spring will be configured of a material cable of resisting the fluid to be projected (heat, cold, wear, abrasion, etc. resistant). In most cases, one guard will be sufficient, but in others, more than one guard is contemplated, possible positioned around the exhaust nozzle of the projection device. The guard may be equipped with a cap at its end farthest from the nozzle which will permit contact with the surface and provide a definite limitation to the approach to the surface. A properly designed guard will allow the tip of the spring to be placed near or on a surface at a distance that will produce the desired effects of the projected fluid but also prevent any damage possibly caused by the application of the fluid.

### DETAILED DESCRIPTION

A particular embodiment that is contemplated is for use with superheated steam generators. A guard is contemplated as comprising at spring positioned in line with a steam exhaust nozzle at a length determined to prevent damage to surfaces by the steam. Other embodiments may have more than one spring. The spring is affixed to the steam generator next to the steam exhaust nozzle generally parallel to the nozzle and the direction of the generated steam. The spring, or springs, may be equipped with a hard, plastic cap at the end intended to contact a surface. The purpose of the guard is to prevent a user from taking the device to close to soft matter such as PPE (cloth) or paper. The steam and steam gas velocity may be 10 m/s at the hot exit at about 400° C. Paper burns (spontaneously ignites) at 250° C. The spring guard allows lateral flexibility but prevents too hot a gas from impinging on a substrate that could brown or burn.

The spring needs to be made of a material that withstands 500° C., allows lateral flexibility, does not corrode in steam or air, adheres to the hard, plastic cap and can be welded to an attachment that screws on to the steam generator nozzle (high temperature alloy). The guard may be comprised of an appropriate metal, ceramic, semiconductor, plastic, composite or combination of the foregoing materials in a manner that is appropriate for the particular contemplated application. In one embodiment the coil is constructed of material of about ⅛″ in diameter and is 3″-6″ in length. It is comprised of a lightweight spring that does not absorb the emitted heat of the steam. A spring configuration allows for fixturing (between the coils of the spring) of temperature indicators and light biomarkers to enable a way of ensuring that that the steam impact region is at a point where a microbe load reduction efficacy is assured.

In operation the tip of the spring may be placed on the surface if necessary. The spring will be designed at a length that will prevent the steam from getting near enough to a surface to burn or brown it. The spring may be configured at lengths to accommodate the heat resistances of various materials. The spring configuration will allow some lateral (sideways) movement along the surface perpendicular to the steam flow. Stiffness in the spring is important to prevent excessive bending that would allow the steam to get too close to the surface.

The word guard, whether a spring or not, may be used to designate an appropriate flexible member, or members, that can hold up to a particular thermal and chemical environment. The member may be coiled or not depending on the particular application. If an elastic spring constant is required, it is assumed to be of a material that can retain the springiness and flexibility without deformation at the temperature of the environment. For example, spring steel can be used easily up to 400° C.

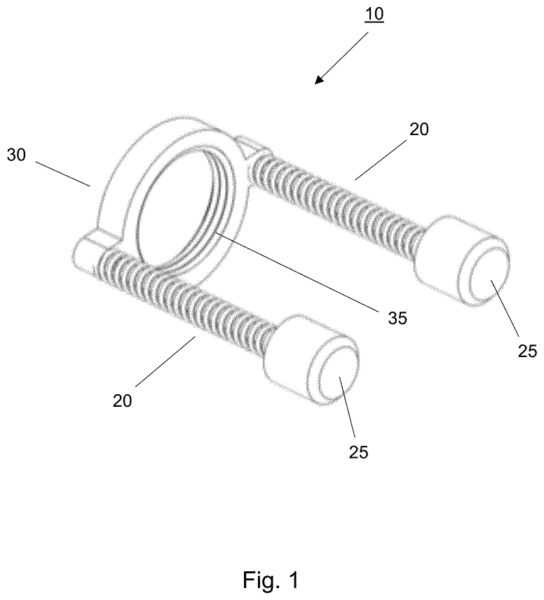

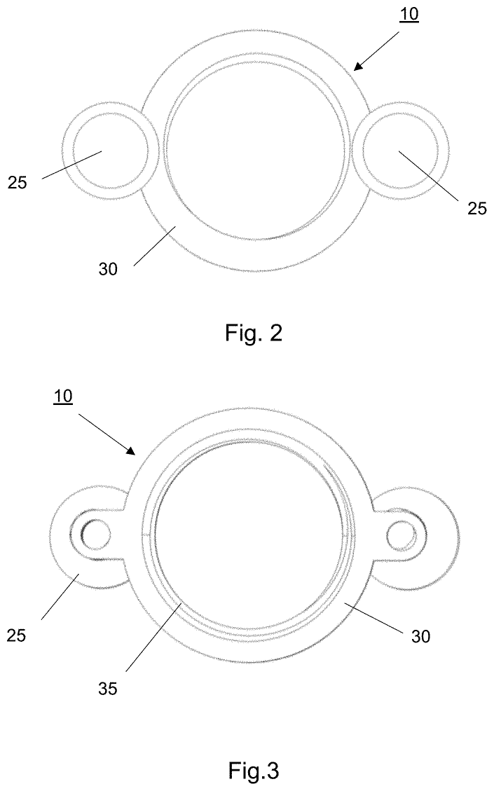

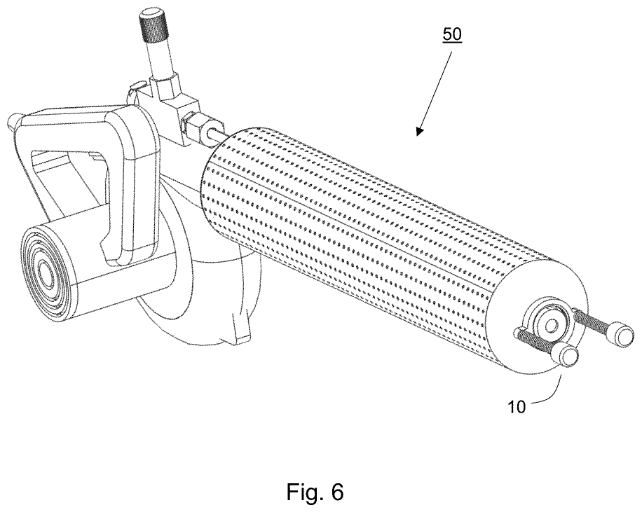

FIG. 1 depicts an overall view an embodiment of the fluid nozzle guard 10 comprised of two spacer arms 20 attached to a base 30. FIG. 2 shows the front of the guard 10 while FIG. 3 shows a rear view. The base 30 is fitted with threads 35 on an interior surface allowing the guard 10 to be attached to a fluid application device likewise provided with threads. Such attachment would be located at the exhaust end or fluid port of such a device. Other forms of attachment including clamping, welding, brazing, soldering, friction fitting or integral connecting are contemplated as well. FIG. 6 shows an embodiment of such a fluid generating devices, specifically, a superheated steam generator 50.

In the embodiment of FIG. 1 the spacer arms 20 are comprised of coil springs. The spacer arms 20 have caps 25 attached to their ends opposite to the attachment to the base 30. The caps 25 are meant to encounter a working surface to provide the optimum distance for application of a fluid or to prevent damage to the working surface caused by the fluid (high temperature or abrasive fluids). The length of the arms 20 may be designed to meet specific application parameters. The spring construction of the arms 20, as in this embodiment, allow for some lateral movement of the arms 20 and applied fluid in relation to the working surface. The stiffness of the springs may be altered to allow for more or less lateral movement depending on the application. In cases were such movement is undesired the arms 20 may be comprised of solid material.

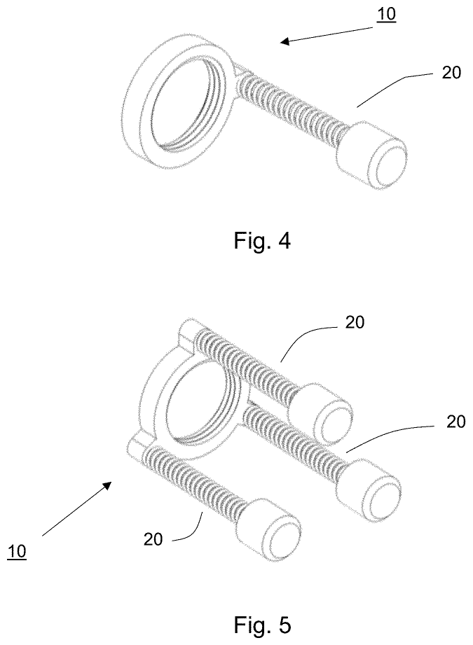

Other contemplated embodiments include a guard 10 comprised of one spacing arm 20 shown in FIG. 4 and a guard 10 comprised of three spacing arms 20 depicted in FIG. 5.

FIG. 6 represents a superheated steam generator 50 fitted with a fluid nozzle guard 10 that will prevent the application of high temperature steam at too close a distance to a working surface.

We claim:

1. A guard for the prevention of damaging contact to a working surface from a projected fluid originating from a fluid projection device having a nozzle which imparts a direction to the projected fluid comprising; at least one spacing arm having a length, a diameter, an inner end toward the nozzle and an outer end away from the nozzle, wherein the guard is mechanically affixed to the fluid projection device in a configuration wherein the length of the at least one spacing arm is generally parallel to the direction of the projected fluid.

2. The guard of claim 1 wherein the spacing arm comprises a spring.

3. The guard of claim 2 wherein the spring is a coil spring.

4. The guard of claim 1 comprised of a material from the list comprised of a metals, ceramics, semiconductors, plastics and composites as appropriate for the environment of the application.

5. The guard of claim 1 further comprising a plastic cap affixed to the outer end of the spacing arm.

6. The guard of claim 1 further comprising multiple spacing arms.

7. The guard of claim 1 further comprised of a second spacing arm.

8. The guard of claim 1 further comprising a ring positioned at the inner end wherein the ring is internally threaded allowing the guard to be mechanically attached to the nozzle wherein the nozzle is threaded.

9. The guard of claim 1 wherein the guard is mechanically affixed to the fluid projection device by an attachment means from the list comprised of a clamp, a weld, a screw, an adhesive and a friction fit.

10. The guard of claim 1 wherein the projected fluid is superheated steam.

11. A method for the application of an applied fluid wherein the distance between a source of the applied fluid and a working surface to be contacted by the applied fluid is controlled by a guard comprising; a spacing arm having a length, a diameter an inner end toward the nozzle and an outer end away from the nozzle, wherein the guard is mechanically affixed to the fluid projection device in a configuration wherein the length of the spacing arm is generally parallel to the direction of the projected fluid.

12. The method of claim 11 wherein the spacing arm comprises a spring.

13. A superheated steam generator comprised of a guard comprising; at least one spacing arm having a length, a diameter an inner end toward the nozzle and an outer end away from the nozzle, wherein the guard is mechanically affixed to the superheated steam generator in a configuration wherein the length of the spacing is generally parallel to the direction of projected superheated steam.

14. The superheated steam generator of claim 13 wherein the at least one spacing arm is comprised of a spring.
